(19) United States
(12) Patent Application Publication
(10) Pub. No.: US 2013/0312313 A1
(43) Pub. Date: Nov. 28, 2013

(54) INSECT TRAP WITH ENCAPSULATION SYSTEM

(71) Applicants: Leonard R. Lefkowitz, Schenectady, NY (US); Ana Diaz, Schenectady, NY (US)

(72) Inventors: Leonard R. Lefkowitz, Schenectady, NY (US); Ana Diaz, Schenectady, NY (US)

(21) Appl. No.: 13/529,311

(22) Filed: Jun. 21, 2012

Related U.S. Application Data
(60) Provisional application No. 61/650,739, filed on May 23, 2012.

(51) Int. Cl. A01M 1/10; A01M 1/14; A01M 1/02

(52) U.S. Cl. 43/114

(57) ABSTRACT

Disclosed herein is an insect trap that includes at least one of an encapsulated adhesive and an encapsulated insect attractant. The encapsulated adhesive and the encapsulated insect attractant may be disposed on a housing. Further disclosed herein is a method that includes providing an insect trap including at least one of an encapsulated adhesive and an encapsulated insect attractant and releasing the at least one of the encapsulated adhesive and the encapsulated insect attractant.

### RELATED APPLICATION

The present invention is a non-provisional claiming priority to a commonly owned U.S. Provisional Patent Application Ser. No. 61/650,739, filed May 23, 2012, of Lefkowitz, entitled “Insect Trap with Encapsulation System,” the disclosure of which is herein incorporated by reference to the extent not inconsistent with the present disclosure.

### FIELD OF THE DISCLOSURE

The subject matter disclosed herein relates generally to insect traps. More particularly, the subject matter relates to an insect trap with an encapsulation system and method of use thereof.

### BACKGROUND

Various devices have been used to control, destroy and trap detrimental insects. Insect traps may be used to control the population of insects that might be harmful to human health, or even damaging to crops. These devices typically employ a structure on or within which both an insect attractant and an adhesive are disposed. Attractants may consist of chemicals that are specific to a particular type of insect or group of insects. Most insect traps operate by attracting and trapping insects with an adhesive on the tarsus (feet) to affect immobility.

Many insect traps commercially available today are sold in a three-dimensional form. These traps include a cavity within a housing that holds the attractant and adhesive. In other embodiments, the traps are sold in a two-dimensional form. These traps take up less space for distribution. However, these traps require a user to unfold or otherwise create the three dimensional shape. Then, a user must apply the attractant and/or adhesive after purchase and before employment of the trap. Application of an attractant may expose a person to various unpleasant chemicals.

Thus, an insect trap utilizing an encapsulated adhesive or an encapsulated insect attractant and method of use thereof would be well received in the art.

### BRIEF DESCRIPTION

According to one aspect, an insect trap comprises at least one of an encapsulated adhesive and an encapsulated insect attractant.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a perspective view of an insect trap according to one embodiment after being fully opened;

FIG. 2 depicts a perspective view of the insect trap of FIG. 1 after being partly opened;

FIG. 3a depicts a perspective view of the insect trap of FIGS. 1-2 in a flat closed state prior to opening;

FIG. 3b depicts a side cutaway view of the insect trap of FIGS. 1-3a taken at arrows 3b-3b, in a flat state prior to opening;

FIG. 4a depicts a particle representation of encapsulated solvents with non encapsulated adhesive particles;

FIG. 4b depicts a particle representation of encapsulated solvents with encapsulated adhesive particles;

FIG. 4c depicts a particle representation of a single encapsulated adhesive particle containing all of the components of an adhesive;

FIG. 4d depicts a particle representation of an encapsulated activator particle that is isolated from the other constituents of an adhesive;

FIG. 4e depicts a particle representation of an encapsulated cure agent in the vicinity of an adhesive;

FIG. 4f depicts a particle representation of an encapsulated insect attractant;

FIG. 5 depicts a side cutaway view of another embodiment of an insect trap prior to opening;

FIG. 6 depicts a side cutaway view of the insect trap of FIG. 5 after opening;

FIG. 7 depicts a side cutaway view of yet another embodiment of an insect trap prior to opening;

FIG. 8 depicts a side cutaway view of the insect trap of FIG. 7 after opening;

FIG. 9 depicts a perspective view of another embodiment of an insect trap prior to opening;

FIG. 10 depicts a perspective view of the insect trap of FIG. 9 after opening;

FIG. 11a depicts a perspective view of a partially flattened tubular insect trap according to yet another embodiment;

FIG. 11b depicts a perspective view of the tubular insect trap of FIG. 11a after being opened;

FIG. 12a depicts a perspective view of a partially closed insect trap according to yet another embodiment; and

FIG. 12b depicts a perspective view of the insect trap of FIG. 12a after being opened.

### DETAILED DESCRIPTION

A detailed description of the hereinafter described embodiments of the disclosed apparatus and method are presented herein by way of exemplification and not limitation with reference to the Figures.

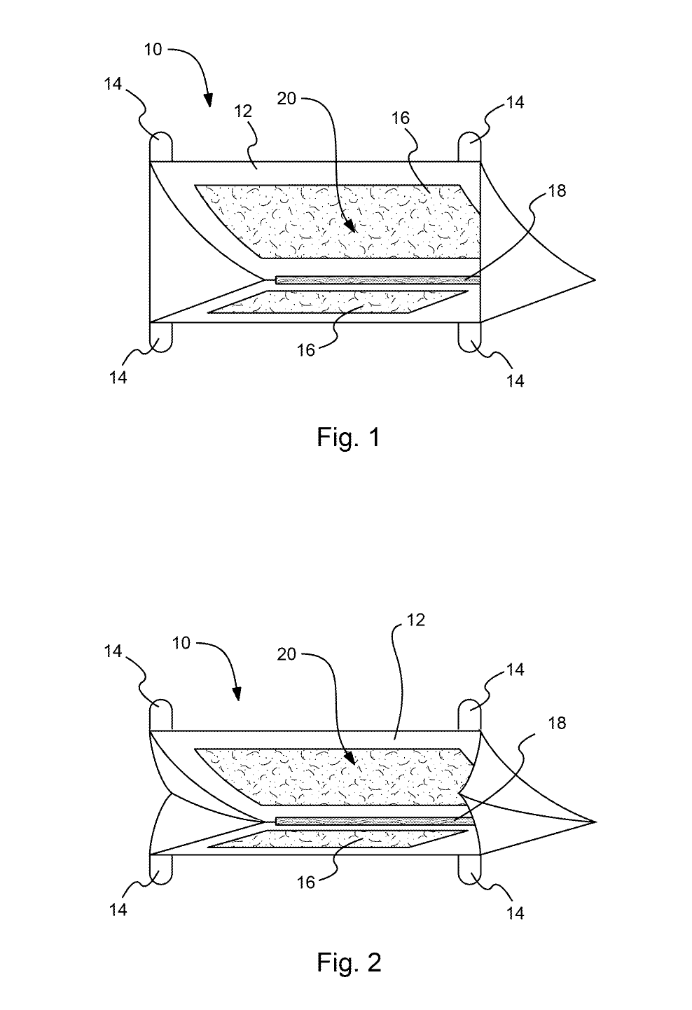

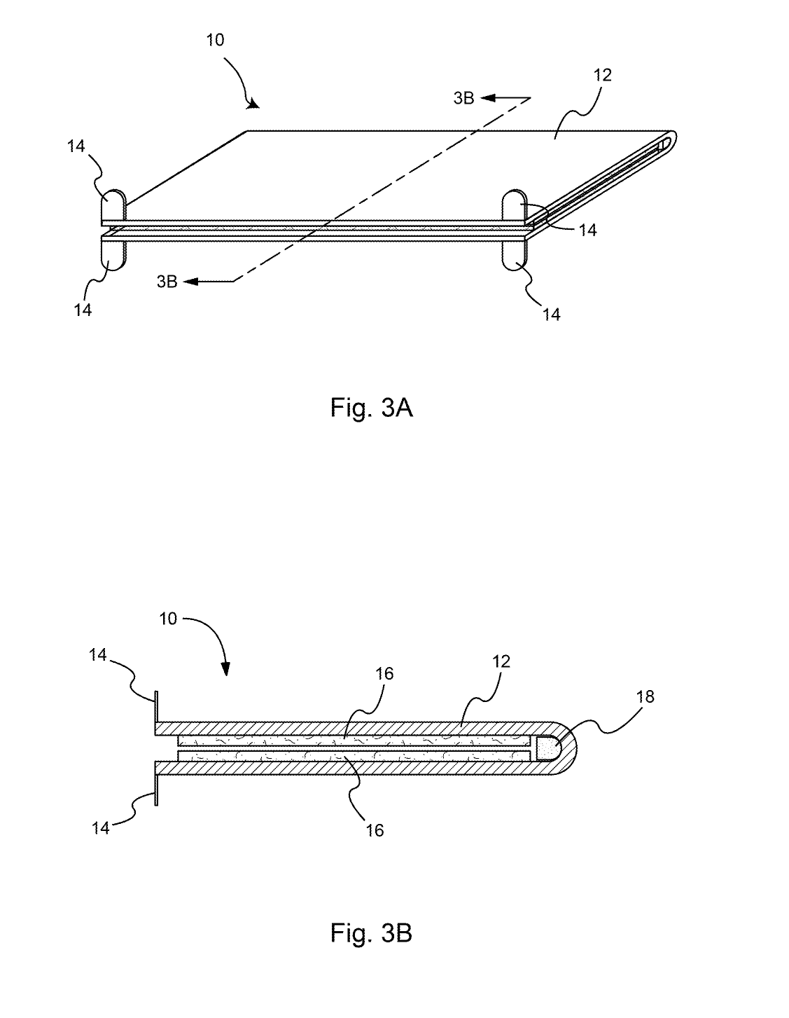

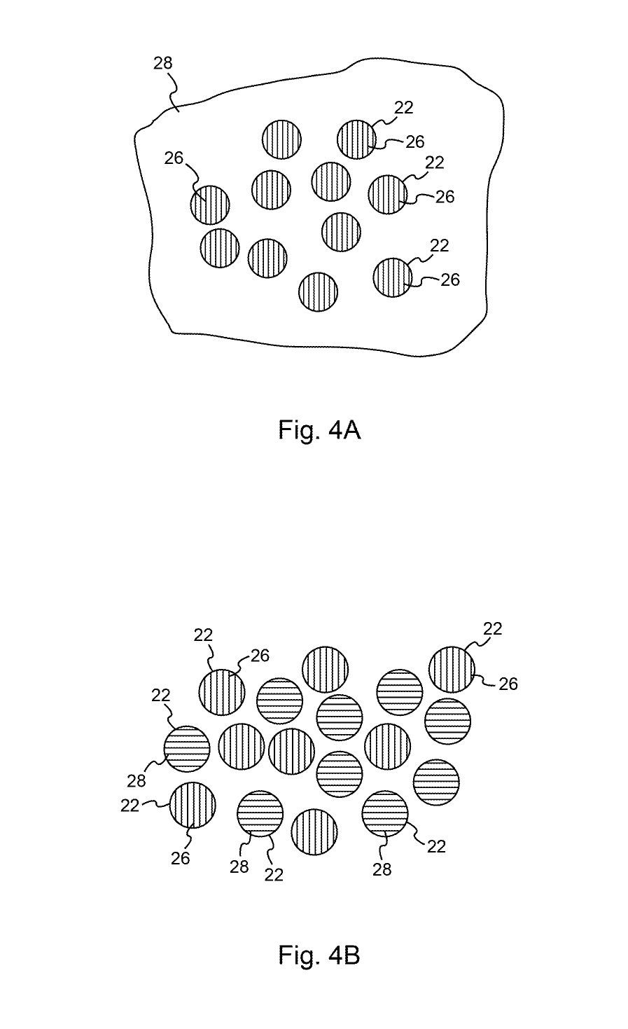

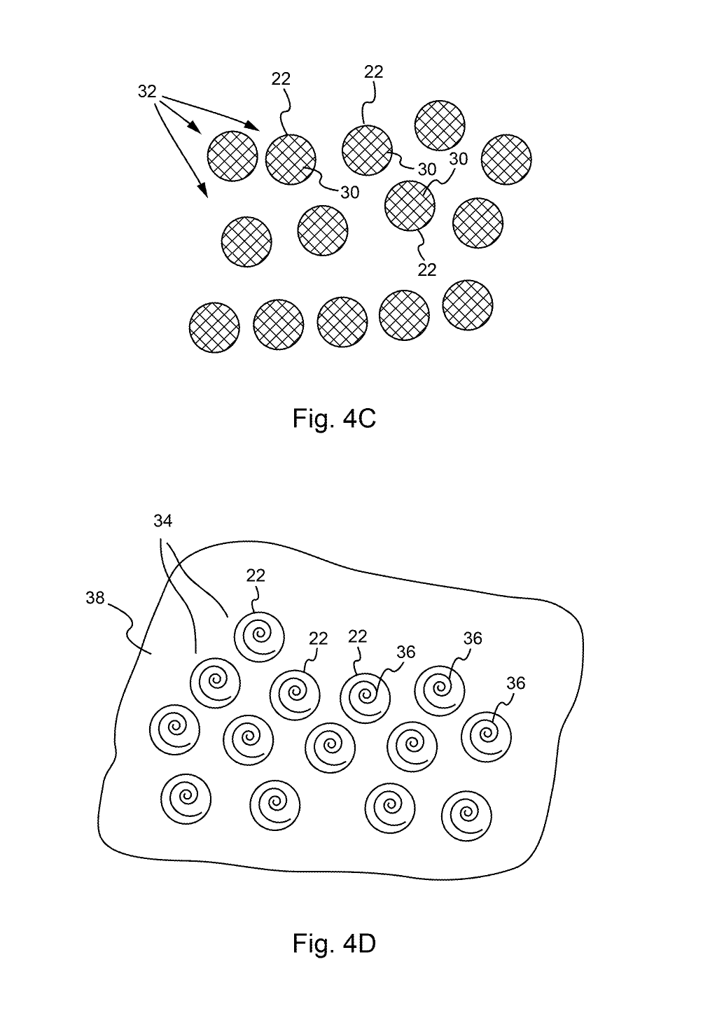

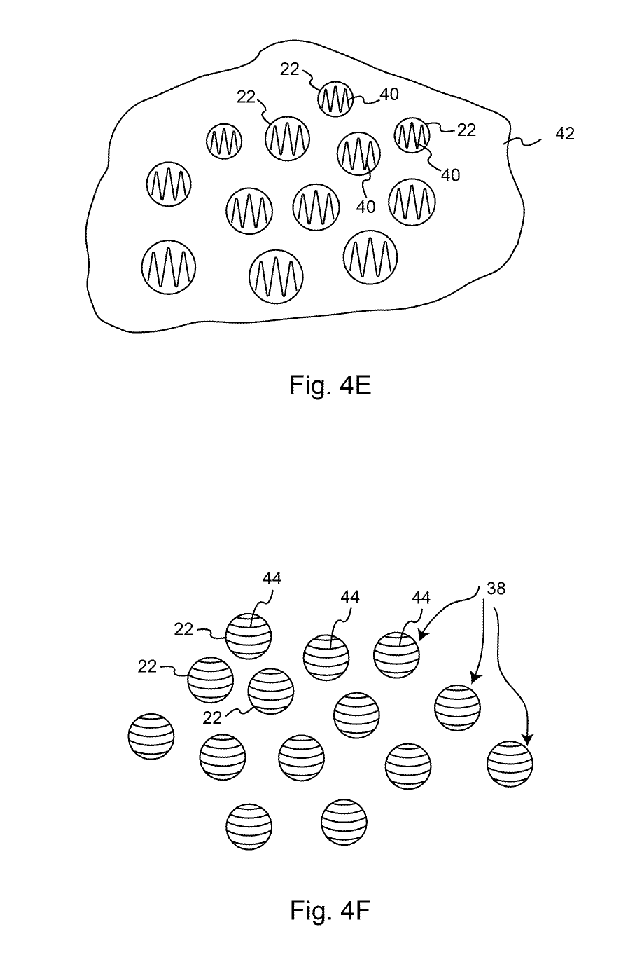

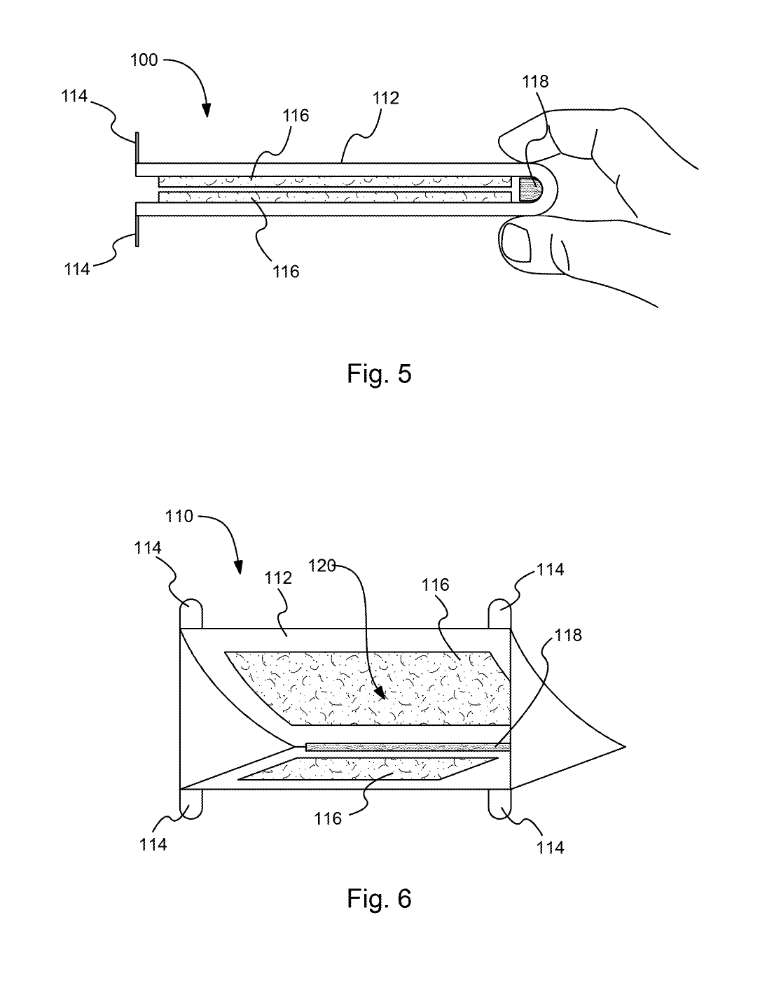

Referring first to FIG. 1-3, an insect trap 10 is shown in accordance with one embodiment. The insect trap 10 includes a main body 12 having a plurality of pull tabs 14 in which are configured to exact a mechanical movement on the insect trap 10 when pulled by a user to transform the insect trap 10 from a two dimensional compact flat form, as shown in FIGS. 3a and 3b, to a three dimensional form, as shown in FIG. 1. The insect trap 10 includes an adhesive 16 and an attractant 18 each located within a cavity 20 of the main body 12. One or both of the adhesive 16 and the attractant 18 may be encapsulated with a shell, coating or membrane 22 (shown in FIGS. 4), forming encapsulated particles. In one case, and particularly in the case of the embodiment shown in FIGS. 1-3, the adhesive material, or at least a portion of the adhesive material, may be the core or fill of the encapsulated particles. The shell, coating or membrane 22 of the encapsulated particles may be configured to break upon the application of a mechanical force, or any appropriate activating means. Thus, the insect trap 10 may be packaged in a flat or two-dimensional form. This may reduce the size of the packaging of the insect trap 10. Then, the opening of the trap 10 by a user, shown in FIGS. 1 and 2, may result in the breaking of the shells 22 of the encapsulated particles, thereby releasing the adhesive to ready the insect trap 10 to catch the appropriate insect(s). In other embodiments, shown in FIGS. 5-8, the insect attractant may also be encapsulated instead of, or in addition to, the adhesive.

Various ways are contemplated in which the encapsulated particles may be utilized on the insect trap 10. In a first embodiment, shown in FIG. 4a, the core or fill may include encapsulated solvents 26. Non-encapsulated solid adhesives 28 may be located in the vicinity of the encapsulated solvents 26 that are soluble to the solvent 26 on the insect trap 10. Upon application the breaking of the shell or membrane 22, the solvent 26 may dissolve or at least tackify the adhesive 28 whereby, upon evaporation or absorption of the solvent 26, an adhesive bond is formed. It should be understood that this combination of solvent and solid adhesive particles may be applied to the appropriate location of the insect trap 10. In other words, this combination of particles may comprise the adhesive portion 16 shown in FIGS. 1-3. Either the encapsulated solvents 26 or the solid adhesive 28 may be applied first to the insect trap 10. For example, the solid adhesive 28 may be precoated onto the cavity 20 of the insect trap 10, followed by the encapsulated solvent 26.

FIG. 4b shows a similar embodiment to FIG. 4a, where instead the solid adhesives 28 are also encapsulated by shells 22. Upon breaking of both the encapsulated adhesive 28 and the solvent 26, absorption of the solvent 26 by the adhesive 28 allows the sticky nature of the adhesive to become present. Where the solvent 26 is non-evaporating, e.g., a plasticizer, and neither the substrate carrying the adhesive nor the substrate to which it is to be bonded absorb the non-volatile solvent 26, the result of the combination of the solvent 26 and the adhesive 28 is a pressure sensitive adhesive. Adhesives based on polyvinyl acetate, rubber, nitrile rubber, ethyl cellulose, or other cellulose derivatives such as cellulose acetate may be suited for the solvent activation/reactivation type application. These are not limiting, however. Again, this combination of encapsulated particles may comprise the adhesive portion 16 shown in FIGS. 1-3.

In the case of a preapplied encapsulated adhesive such as by the particles in FIGS. 4a and 4b, the liquid adhesive composition containing encapsulated particles may be dispersed within the cavity 20 or other appropriate trapping surface of the insect trap 10. A polymer film (not shown) may be formed over and encase the adhesive composition on the area which it is applied. The polymer film may hold the liquid adhesive composition in place and form a protective barrier as well as a dry to the touch surface for the adhesive composition.

FIG. 4c shows another type of encapsulated particle that may be utilized. In this embodiment, the components of an adhesive 30 may be encapsulated into a single particle 32. These encapsulated particles 32 may be applied to the substrate of the cavity 20 of the insect trap 10 in a binder system that is non-tacky and dry to the touch until the capsule walls or shell 22 is broken releasing and exposing the encapsulated adhesive. The adhesive may be a curable adhesive that cures to a tacky state, for example, when exposed to air. For example, a tackifying resin may be used in the encapsulated particles 32 to render the coating tacky, even after complete cure. However, the shell 22 may prevent exposure until it is broken.

FIG. 4d shows another type of encapsulated particle 34. This encapsulated fill is an activator, initiator, catalyst or accelerator 36. This activator fill 36 may affect polymerization or curing of the composition so as to form the desired adhesive or sealant. The activator or activator fill 36 is isolated from the other constituents 38 of the adhesive. Upon breaking of the shell 22, the activator fill 36 may be configured to make the composition fully adhesive.

FIG. 4e shows another embodiment where the insect trap 10 contains encapsulated cure agents 40 that are coated with non-tackified adhesive 42. Upon mechanical motion, the encapsulated cure agent could be caused to release into the non-tackfied adhesive 42. This may activate the adhesive and, for example, make it tacky. The curing agent may be a tackifying resin that renders the adhesive tacky, even after complete cure.

In the embodiments shown in FIGS. 4c-4e, the encapsulated particles, including liquid polymerizable components, may be dispersed in a liquid curable, polymerizable, or hardenable binder system (not shown). One or more curing agents or one or more activators, catalysts, initiators or accelerators for affecting curing or polymerization of the encapsulated liquid may be dispersed in the binder, without encapsulation. Alternately, all of the components of the adhesive composition may be encapsulated. In use, each of these modified binder systems may then be applied to the cavity 20 or other appropriate trapping surface of the insect trap 10 and allowed to cure, polymerize or tackify; thereby binding the encapsulated particles to the surface. Suitable binder systems may or may not co-react to the adhesive composition during cure or polymerization of the same. Activation of these encapsulated adhesives is effectuated by breaking the microcapsules so that the liquid polymerizable component comes into contact with the curative, curing agent, activator, catalyst, initiator, accelerator or the like.

Furthermore, the encapsulated components of the adhesive 16 may not be configured to activate the adhesive immediately upon being released from the shell 22 due to the breaking of the shell 22. Instead, another activating force may be required. In order to be activated, the encapsulated portion(s) of the adhesive may be required to react to any of either exposure to air, water, gaseous elements, light, UV light or other such stimulant to provide activated sites on the inner surfaces of the trap for the capture of desired target pests.

FIG. 4f shows another type of encapsulated particle 38. The fill of the encapsulated particle 44 may be the insect attractant, rather than the adhesive in this embodiment. The same principles applicable above may be applied to the application and activation of the encapsulated particle 44 of the attractant. Like embodiments of the encapsulated adhesive, the encapsulated attractant, when released from the shell 22, may still not be activated. In order to be activated, the encapsulated attractant may be required to react to any of either exposure to air, water, gaseous elements, light, UV light or other such stimulant to provide activated sites on the inner surfaces of the trap for the capture of desired target pests.

It should be understood that the shell, coating or membrane 22 of the above examples may be made of a variety of materials known in the art of encapsulation. For example, organic polymers waxes, and fats are all contemplated. Furthermore, the type of encapsulation technique is also variable. Encapsulation techniques may include, for example, pan coating, air suspension coating, centrifugal extrusion, using a vibrational nozzle, spray drying, ionotropic gelation, coacervation, interfacial polycondensation, interfacial cross linking, in-situ polymerization, and matrix polymerizationn.

As described hereinabove, release of the encapsulated material may be triggered by the rupturing of the shell 22. Walls may be ruptured easily by pressure or shear stress by flexing, bending, or the like of the main body 12. Other embodiments are contemplated, however. For example, capsule contents may be released by melting the shell 22, or dissolving it under particular conditions. In other systems, the wall may be broken by solvent action, enzyme attack, chemical reaction, hydrolysis, or slow disintegration. Sound, light or any other physical means may also be used to trigger the rupturing of the shell 22. For example, in the embodiment shown in FIGS. 1-3, the breaking of the shell 22 of any encapsulated particles may be effectuated by the opening of the main body 12 as shown in FIGS. 1 and 2.

It should be understood that the invention is not limited to the above-described encapsulation embodiments. These embodiments are simply meant to be exemplary of the basic principles of encapsulating an adhesive and/or attractant for application in an insect trap, such as the insect trap 10.

Referring back to FIGS. 3a and 3b, the insect trap 10 is shown in a compact flat form that may be advantageous for storage and distribution prior to usage. The insect trap 10 includes the main body 12. Within the main body is a layer of the adhesive 16. The adhesive 16 may be applied to most of the surface area inside of the main body 12. The adhesive layer 16 shown in FIG. 3b includes encapsulated material to preserve the adhesive for use. It should be understood that any configuration of adhesive material is contemplated, including, but not limited to, those described hereinabove in FIGS. 4a-4d.

Further shown in FIG. 3b is the insect attractant 18 applied to the distal end relative to the pull tabs 14. It should be understood that the insect attractant 18 described herein may be configured to attract any type of insect that it would be desirable to trap. For example, the attractant 18 may be configured to trap spiders, bees, roaches, beetles, mites, flies, moths, worms, centipedes, millipedes, gnats, mosquitoes, and the like. This list is by no means exhaustive. In one embodiment, the insect attractant 18 may be configured to attract multiple types of insects. Thus, when the main body 12 is opened, the insect attractant 18 is exposed. An insect must travel through the adhesive 16 in order to reach the insect attractant 18.

In FIGS. 3a and 3b, the cavity 20 has not been formed. In order to form the cavity 20, the insect trap 10 is configured to be pulled by the tabs 14. When a person pulls the tabs 14, the main body 12 opens to form the cavity 20. The encapsulated materials are configured to release when a person pulls the tabs 14 in order to open the insect trap 10, shown in FIGS. 1-2. As described hereinabove, the adhesive 16 may include encapsulated materials. Thus, prior to pulling the tabs 14, the adhesive 16 is preserved. Then, once the tabs are pulled, the adhesive 16 may be activated by the breaking of the shells 22 of the encapsulated material. This embodiment allows for the compact distribution of the device, and also does not require a person to apply any unpleasant chemicals by hand to the insect trap 10.

Another embodiment of an insect trap 100 is shown in FIGS. 5-6. Like the insect trap 10, the insect trap 100 includes a main body 112, an adhesive layer 116 and an insect attractant 118. The insect trap 100 is shown in FIG. 5 to be in a compact flat form, similar to the insect trap 10 shown in FIG. 1. In this embodiment, however, the adhesive layer 116 may or may not include encapsulated materials that are configured to release when the insect trap 100 is opened. In this embodiment, however, the insect attractant 118 includes encapsulated materials. In particular, the encapsulated materials in this embodiment are configured to release when a person squeezes the insect attractant 118 together either before or after opening the insect trap 100. This squeezing may be prompted with instructions that come with the insect trap 100. Alternately the instructions to “squeeze here to release attractant,” or similar instructions, may be found on a label on the outside of the main body 112. Similar to the insect trap 10, the insect trap 100 includes tabs 114 that may be pulled in order to open the insect trap 100 for usage. If the insect trap 100 does not include an encapsulated adhesive 116, a protective layer may be applied to the adhesive that must be removed in order to reveal the adhesive after opening the insect trap 100.

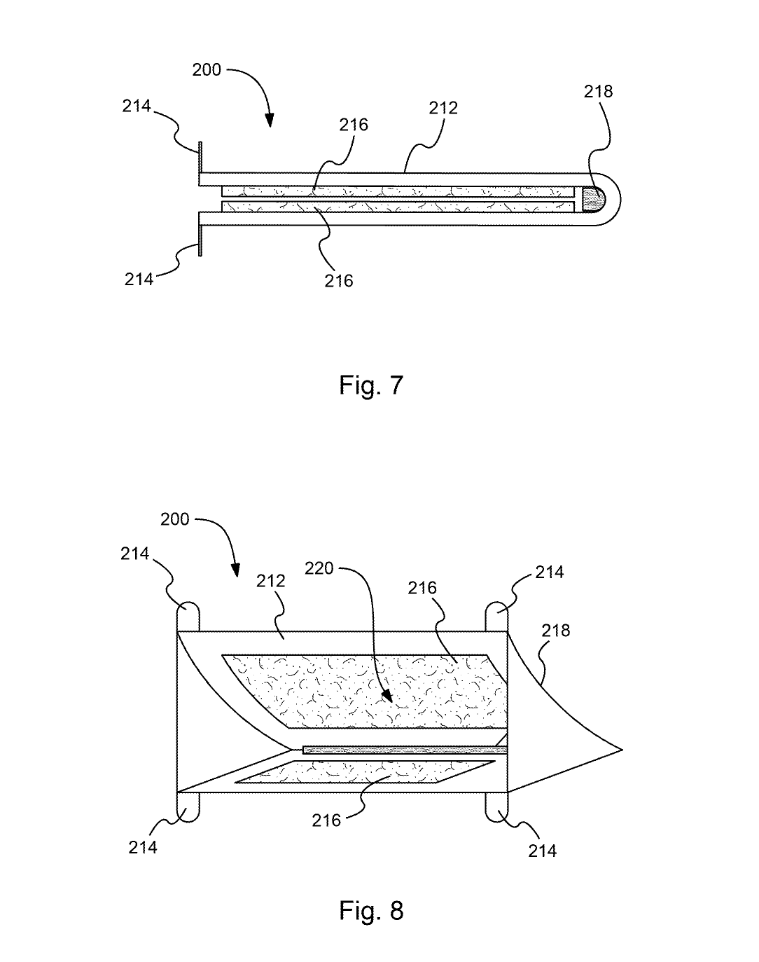

Another embodiment of an insect trap 200 is shown in FIGS. 7-8. This embodiment is also similar to the insect traps 10, 100 described hereinabove. The insect trap 200 includes a main body 212, tabs 214 an adhesive 216 that may or may not include encapsulated materials, and an attractant 218. Like the insect trap 100, the insect trap 200 includes an encapsulated insect attractant 218. However, unlike the insect trap 100, no squeezing is required to break shells 22 and release the attractant. Rather, the attractant 218 may be released simply by pulling on the tabs 214, and opening the insect trap 200, as shown in FIG. 8.

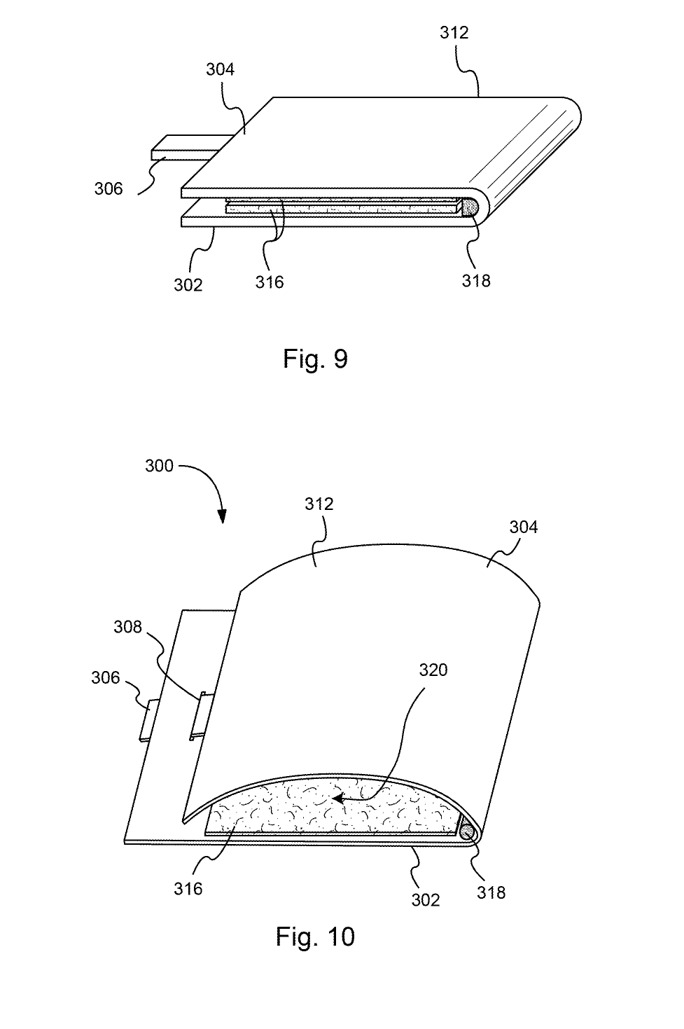

Another embodiment of an insect trap 300 is shown in FIGS. 9-10 both before (FIG. 9) and after (FIG. 10) opening. The insect trap 300 includes a different structural main body 312 than the embodiments shown in the previous Figures. The main body includes a bottom portion 302 that is flat in the open state, and a top portion 304 including a tab 306 that is bent around and inserted back into an opening 308 in the bottom portion 302 in the open state. This insect trap 300 includes an adhesive portion 316 and an insect attractant 318 similar to the insect traps 10, 100, 200 described hereinabove. One or both of the insect attractant 318 and the adhesive 316 may include encapsulated materials in a similar manner to that described hereinabove with respect to the insect traps 10, 100, 200. The insect trap 300 includes a cavity 320 formed between the top and bottom portions 304, 302 when the insect trap 300 is opened. The shells 22 of the encapsulated materials may be configured to break when the insect trap 300 is opened. Alternately, any other form of activation of the encapsulated materials is contemplated.

The insect trap 300 is shown to display that the present invention contemplates traps having any structural shape and size. The embodiments shown in the Figures are meant to be exemplary. In particular, the insect trap may take any shape that can have a surface for holding an adhesive. Simple flat traps are even contemplated that do not have a cavity at all. A flat trap, for example, may include both encapsulated adhesive and encapsulated attractant in combination on the flat surface that is configured to release upon bending of the flat trap. In other embodiments, the trap may be cone shaped, cubical, or cylindrical. Furthermore, the sizes of the trap may be altered depending on the size of the insect that the trap is configured to control. The larger the insect, the larger the trap, and the larger the adhesive portion. The particular locations of the attractant on the traps shown are also not meant to be limiting. Any appropriate location of the insect attractant is contemplated. The insect attractant may also be spread throughout the entire main body or cavity of the trap.

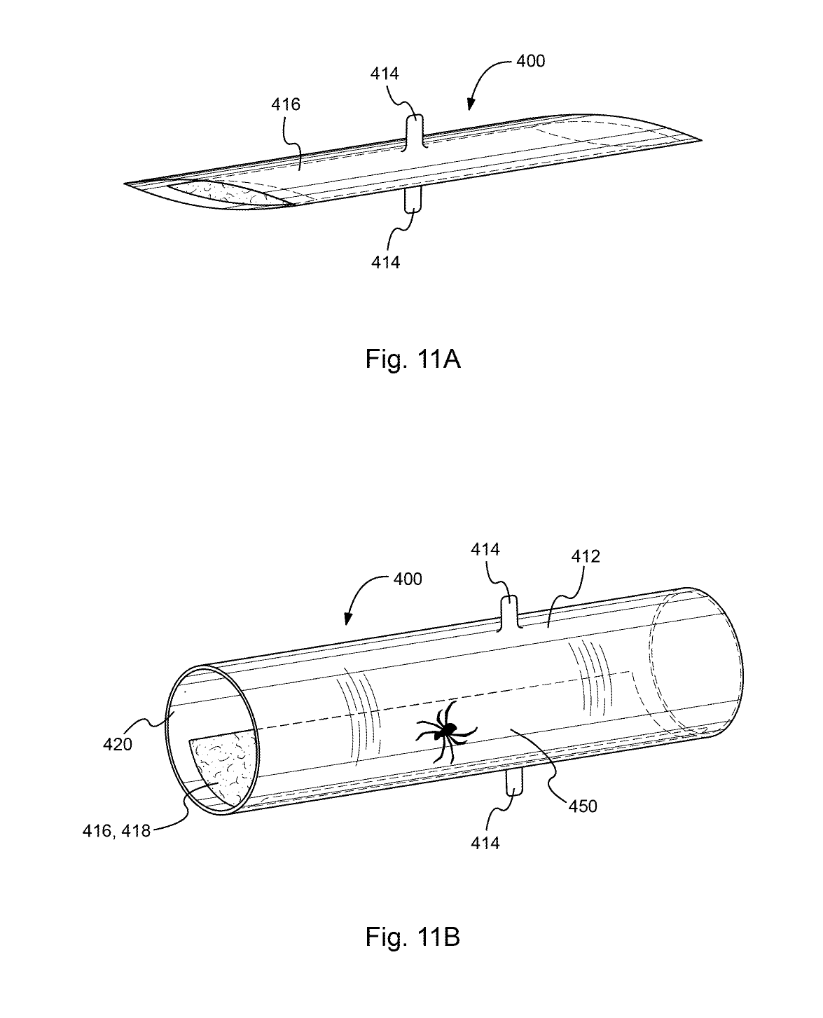

One example of a cylindrical trap 400 is shown in perspective in FIGS. 11a and 11b. The insect trap 400 includes a main body 412 with pull tabs 414, having a cavity 420, within which an adhesive 416 and insect attractant 418 is located. Both the attractant 418, and at least one part of the adhesive 416 may be encapsulated in this embodiment. Furthermore, the main body 412 of the cylindrical trap 400 may be made of a semi rigid, semi elastic material such polyethylene terephthalate, polyvinyl chloride, LDPE, HDPE, polypropylene, or the like. Alternately, the material may be a paper based material. In some embodiments, the main body 412 of the trap 400 may be made of a transparent material in order for a person to be able to see if the trap has caught an insect 450. The cylindrical trap 400 shown in FIG. 11b may be manufactured and shipped in the three-dimensional, open form, unlike the previously described traps 10, 100, 200, 300. In this embodiment, the insect trap 400 may not include the pull tabs 414. To activate the cylindrical trap 400, a user may simply roll the main body 412 between their hands to deform the trap 400. This deformation of the trap 400 may release the encapsulated materials.

The insect trap 400 is shown in a flat state in FIG. 11a and an open state in FIG. 11b. It should be understood that the state shown in FIG. 11a is not perfectly flat. In some embodiments, the insect trap 400 may be flattened even further for distribution and storage. The insect trap 400 may be sold in a flat or unopened state to reduce the volume of the trap for distribution and storage of the trap prior to use. A user may simply pull on the tabs 414 of the insect trap 400 in order to pull the insect trap into an opened cylindrical position, as shown in FIG. 11b. Furthermore, the insect attractant and adhesive 418, 416 is shown only on a single bottom surface on the inside of the cylindrical trap 400. This embodiment is shown for exemplary purposes. In other embodiments, the insect attractant and adhesive 418, 416 may be applied, for example, to less or more of the inner surface, or alternately to the entire inner surface of the cylindrical trap 400.

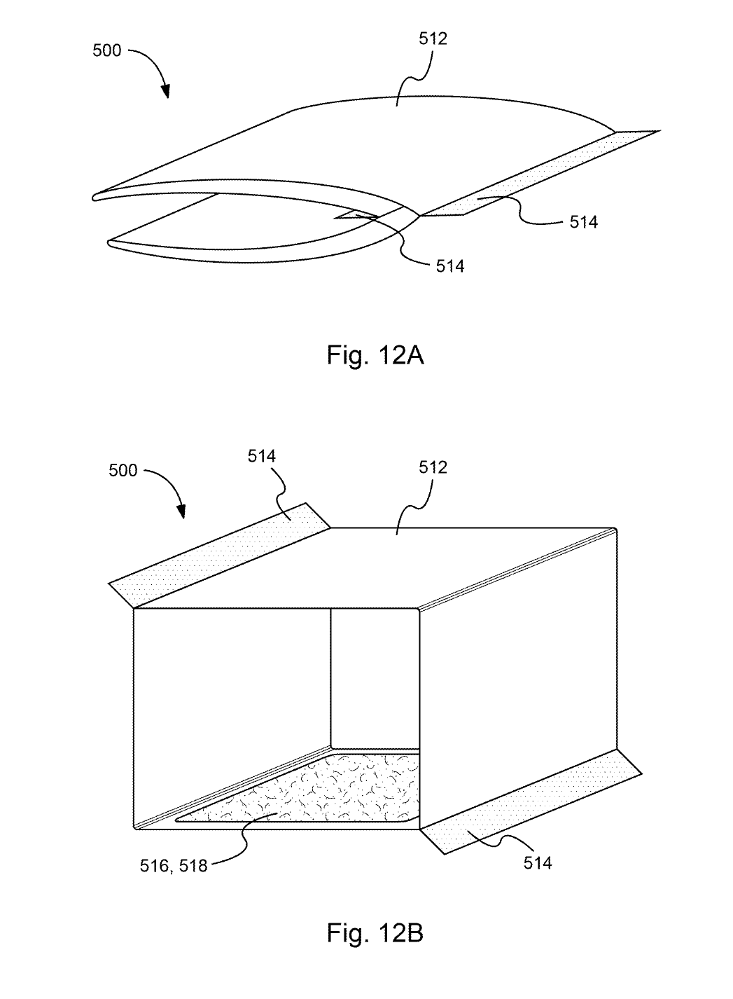

Shown in FIGS. 12a and 12b is another embodiment of an insect trap 500 having a differently structured main body 512. The main body 512 includes tabs 514 such that it can be opened up to have a generally rectangular cross section. In this embodiment, the insect trap 500 may also include a cavity 520 within which an adhesive 516 and insect attractant 518 is located. Both the attractant 518 and the adhesive 516 may be located on one or more inside surfaces of the insect trap 500. In one embodiment, the attractant 518 and adhesive 516 may be located on all of the inner surfaces of the insect trap 500. Like previous embodiments, the insect trap 500 may include a transparent material. The insect trap 500 is shown in FIG. 12a in a closed position. However, it should be understood that the insect trap 500 may be flattened even further than the state depicted in FIG. 12a.

It is contemplated that a universal non-hardening adhesive substance may be developed for implementation on the present invention. It may be less likely to find a universal attractant that will be able to lure all types of undesirable insects to be trapped. As such, it may be found of benefit to create a trap with an adhesive without an attractant. In this case, the attractant may be applied on site depending on the need as it arises. In other words, it may be advantageous to send universal traps with encapsulated adhesive to the field for addition of customized attractant or lures once the trap is in the field.

It should be understood that another advantage of using the shell or encapsulant with attractants, as contemplated herein, is that the full potency of the attractant ingredients may be assured through the protection of the ingredients until the moment of release. In other words, the encapsulant or shell may protect the attractant so that it remains potent until its implementation in the field. The same can be said for the adhesive, which may also be protected by the shell or encapsulant until release. This may increase the shelf life of the insect trap.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

I claim:

1. An insect trap comprising at least one of an encapsulated adhesive and an encapsulated insect attractant.

2. The insect trap of claim 1, wherein the at least one of the encapsulated adhesive and the encapsulated insect attractant is an encapsulated particle in a shell that is configured to yield when subjected to an activation stimulant.

3. The insect trap of claim 2, wherein the activation stimulant is at least one of:
bending a material on which the at least one of the encapsulated adhesive and the encapsulated insect attractant is applied;
melting the shells of the at least one of the encapsulated adhesive and the encapsulated insect attractant;
dissolving the shells of the at least one of the encapsulated adhesive and the encapsulated insect attractant;
exposing the at least one of the encapsulated adhesive and the encapsulated insect attractant to a chemical composition;
exposing the at least one of the encapsulated adhesive and the encapsulated insect attractant to sound;
exposing the at least one of the encapsulated adhesive and the encapsulated insect attractant to air; and
exposing the at least one of the encapsulated adhesive and the encapsulated insect attractant to light.

4. The insect trap of claim 1, further comprising a housing and a cavity, wherein the at least one of the encapsulated adhesive and the encapsulated insect attractant is applied to a surface within the cavity.

5. The insect trap of claim 4, wherein the housing is packaged in a flattened state.

6. The insect trap of claim 5, wherein the housing is openable from the flattened state to an opened state to define the cavity.

7. The insect trap of claim 6, wherein opening the housing releases the at least one of the encapsulated adhesive and the encapsulated insect attractant.

8. The insect trap of claim 4, wherein the housing is made of a transparent material.

9. The insect trap of claim 4, wherein squeezing the cavity together results in a release of the encapsulated insect attractant.

10. An apparatus comprising:
a housing configured to contain an insect; and
at least one of an encapsulated insect attractant and an encapsulated adhesive disposed on the housing.

11. The insect trap of claim 10, wherein the at least one of the encapsulated adhesive and the encapsulated insect attractant is an encapsulated particle in a shell that is configured to yield when subjected to an activation stimulant.

12. The insect trap of claim 11, wherein the activation stimulant is at least one of:
bending a material on which the at least one of the encapsulated adhesive and the encapsulated insect attractant is applied;
melting the shells of the at least one of the encapsulated adhesive and the encapsulated insect attractant;
dissolving the shells of the at least one of the encapsulated adhesive and the encapsulated insect attractant;
exposing the at least one of the encapsulated adhesive and the encapsulated insect attractant to a chemical composition;
exposing the at least one of the encapsulated adhesive and the encapsulated insect attractant to sound;
exposing the at least one of the encapsulated adhesive and the encapsulated insect attractant to air; and
exposing the at least one of the encapsulated adhesive and the encapsulated insect attractant to light.

13. The insect trap of claim 10, further comprising a cavity within the housing, wherein the at least one of the encapsulated adhesive and the encapsulated insect attractant is applied to a surface within the cavity.

14. The insect trap of claim 13, wherein the housing is packaged in a flattened state.

15. The insect trap of claim 14, wherein the housing is openable from the flattened state to an opened state to define the cavity.

16. The insect trap of claim 15, wherein opening the housing releases the at least one of the encapsulated adhesive and the encapsulated insect attractant.

17. The insect trap of claim 10, wherein the housing is made of a transparent material.

18. The insect trap of claim 13, wherein squeezing the cavity together results in a release of the encapsulated insect attractant.

19. A method comprising:
providing an insect trap including at least one of an encapsulated adhesive and an encapsulated insect attractant; and
releasing the at least one of the encapsulated adhesive and the encapsulated insect attractant.

20. The method of claim 20 further comprising opening the insect trap to release the at least one of the encapsulated adhesive and the encapsulated insect attractant.
